(19) United States
(12) Patent Application Publication
(10) Pub. No.: US 2018/0096612 A1
(43) Pub. Date: Apr. 5, 2018

(54) Device, System, and Method for Gate Optimization

(71) Applicant: PASSUR Aerospace, Inc., STAMFORD, CT (US)

(72) Inventors: Noel Alphonso, STAMFORD, CT (US); Leo Prusak, STAMFORD, CT (US); Howard King, STAMFORD, CT (US); Mark Libby, STAMFORD, CT (US)

(21) Appl. No.: 15/726,133

(22) Filed: Oct. 5, 2017

Related U.S. Application Data
(60) Provisional application No. 62/404,437, filed on Oct. 5, 2016.
(60) Provisional application No. 62/404,441, filed on Oct. 5, 2016.

(51) Int. Cl. G08G 5/06; G06Q 10/04

(52) U.S. Cl. CPC G08G 5/065; G06Q 10/109; G06Q 10/04

(57) ABSTRACT

A method performed by an optimization server for receiving an identification identifying an aircraft, identifying a gate assigned to the aircraft upon landing at a destination including the gate, determining whether a gate conflict is expected for the aircraft to use the gate, when there is a gate conflict, determining a resolution for the gate conflict based on actual departure demand information of the gate and providing a notification corresponding to the resolution.

### PRIORITY CLAIM/INCORPORATION BY REFERENCE

The present application claims priority to U.S. Provisional Patent Application 62/402,437 filed on Oct. 5, 2016 entitled “System and Methods for Managing an Airport” naming Noel Alphonso, Leo Prusak, and Howard King as inventors and also claims priority to U.S. Provisional Patent Application 62/404,441 filed on Oct. 5, 2016 entitled “System and Methods for Gate Optimization at an Airport” naming Mark Libby as inventor, and hereby incorporates, by reference, the entire subject matter of these applications.

### BACKGROUND INFORMATION

An airport may include a plurality of gates from which an aircraft may dock and a plurality of operations may be performed. For example, while at the gate, the aircraft may undergo a plurality of stages (e.g., main door opening, cargo door opening, passenger unloading, cargo unloading, aircraft maintenance, passenger loading, cargo loading, main door closing, cargo door closing, etc.). For an arriving flight, an expected gate may be determined and provided to the pilot of the arriving aircraft (or any other aircraft requiring use of a gate) such that the arriving aircraft may taxi from the runway to the expected gate. In determining the expected gate, various information may be used to calculate various estimates which are then used as a basis to determine the expected gate. For example, the information may include an estimated time of arrival (ETA) which provides a measure of when the aircraft is expected to be at a particular position.

The determination of the expected gate may be performed manually or automatically. For example, a user may view information of the airport and the gates including the estimates to select an expected gate for the aircraft to use. In another example, a system may be configured to utilize the information and estimates to automatically determine the expected gate. However, in either approach, conflicts may arise for the arriving aircraft to use the expected gate. For example, over the course of one or more aircraft using the expected gate, delays may accumulate that prevent the arriving aircraft from using the expected gate within a reasonable delay time. By not compensating for such conditions despite efforts to adjust estimates in light of these factors, there may be a plurality of issues that arise due to the delay caused to the arriving aircraft. For example, a passenger may be delayed and be incapable of boarding a connecting flight. In another example, crews (both inside and outside of the aircraft) may be delayed in performing their respective jobs. A conventional manner of resolving the gate conflict is for a user to determine whether the expected gate that is occupied is to be used or redirecting the aircraft to another potentially empty gate. However, this decision is based on the information that is currently available as well as estimates determined from this information (e.g., the redirected gate is expected to be available for an estimated amount of time) and may not incorporate a plurality of considerations that may have adverse consequences to operation of the airport and the gates (e.g., the redirected gate is also undergoing delays and is actually occupied or an arriving aircraft requires immediate use of the redirected gate).

### SUMMARY

Some exemplary embodiments are directed to a method performed by an optimization server. The method includes receiving an identification identifying an aircraft, identifying a gate assigned to the aircraft upon landing at a destination including the gate, determining whether a gate conflict is expected for the aircraft to use the gate, when there is a gate conflict, determining a resolution for the gate conflict based on actual departure demand information of the gate and providing a notification corresponding to the resolution.

Other exemplary embodiments are directed to an optimization server including a transceiver configured to receive an identification identifying an aircraft and a processor identifying a gate assigned to the aircraft upon landing at a destination including the gate, the processor determining whether a gate conflict is expected for the aircraft to use the gate, when there is a gate conflict, the processor determining a resolution for the gate conflict based on actual departure demand information of the gate, the processor generating a notification corresponding to the resolution.

Still further exemplary embodiments are directed to an optimization server including first circuitry for receiving an identification identifying an aircraft, second circuitry for identifying a gate assigned to the aircraft upon landing at a destination including the gate, third circuitry for determining whether a gate conflict is expected for the aircraft to use the gate, when there is a gate conflict, fourth circuitry for determining a resolution for the gate conflict based on actual departure demand information of the gate and fifth circuitry for providing a notification corresponding to the resolution.

### BRIEF DESCRIPTION OF THE DRAWINGS

FIG. 1 shows an exemplary system for resolving a gate conflict according to the exemplary embodiments.

FIG. 2 shows an exemplary optimization server of the system of FIG. 1 according to the exemplary embodiments.

FIG. 3 shows an exemplary method of resolving a gate conflict according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a device, system, and method for resolving a gate conflict arising at an airport for a selected aircraft (e.g., an arriving aircraft). In resolving the gate conflict, the exemplary embodiments are configured to utilize information including both estimated and actual information corresponding to departure times and dynamically update this information based on automatically determined data and manually entered data. The exemplary embodiments further provide a plurality of features to a user interface for information to be viewed, particularly when a manual input is used in the gate resolution and to receive the manually entered data.

Initially, it is noted that the exemplary embodiments are described with regard to gate conflicts and using actual information of departure times as a consideration in resolving the gate conflicts. However, the gate conflict is only an exemplary scenario and the actual departure demand is only an exemplary consideration. The exemplary embodiments may be implemented and/or modified to be used for any conflict resolution, particularly for aircraft and when a position for the aircraft results in a conflict. The exemplary embodiments may also utilize other information beyond actual departure demands and conventionally available information including estimates.

The exemplary embodiments provide a mechanism to manage an airport, particularly through gate optimization. Specifically, the mechanism according to the exemplary embodiments include tools to aid in assuring on-time arrivals and departures and prioritized handling of high-value flights, faster turn times to ensure airframe, gate, and crew assets are optimized, reductions in gate holds, tarmac delays, and extended taxi queues and reductions in diversions and delays through proactive management of unpredicted capacity changes and disruptions. According to one aspect of the mechanism according to the exemplary embodiments, advanced surface management at the airport may prioritize high-value flights and proactively avoiding gate conflicts through advance alerts and notifications created for arriving aircraft at risk for a gate conflict. Such advance notice ahead of arrival by the aircraft may enable a window of decision flexibility to preserve on-time arrivals and connections (e.g., bags, passengers, crew, etc.) and reduce gate holds by proactively adjusting gate plans.

As will be described in further detail below, the notice may be generated for all key flight metrics being tracked or identified by users, thereby enabling users to stay informed and proactive whether the user is in the operations center or located remotely on a mobile device. The notice may also allow a team to be mobilized around specific critical operational priorities by creating critical flight information (e.g., crew timeout deadline, tight flight crew connections, etc.). The notice and a user interface according to the exemplary embodiments allow for an improvement and maximization of productivity through options to customize the way a user views and receives information (e.g., easier display of critical flight information, easier ability to quickly turn on or off layers of airport surface information, new color and text options, etc.).

The user interface also provides for proactively optimizing arrivals and departures through a layer of predictive visibility for an accurate view of actual departure demand available by airport (e.g., schedule, delays, cancellations, actual queued/taxiing departures, etc.) to match a true arrival demand, thereby significantly expanding the ability to proactively adjust to constantly changing capacity (e.g., accelerating a flight boarding to take advantage of an unplanned increase in departure capacity for high-value flights). The user interface further provides a user situational awareness on a flight's progress from departure origin to its arrival at the terminal gate through accurate information on flights operating in and out of all terminals/gates of an airport. Thus, a user may be aware of when a flight is expected to arrive, when it lands, when it is inbound to the gate, when it arrives at the gate, etc. The user may also become aware of last minute gate changes and gate dwell times which are incorporated into resolving gate conflicts. The exemplary embodiments also show when gates are available, when they are scheduled to be closed, and when they are out of service, all of which may factor into gate conflict resolution.

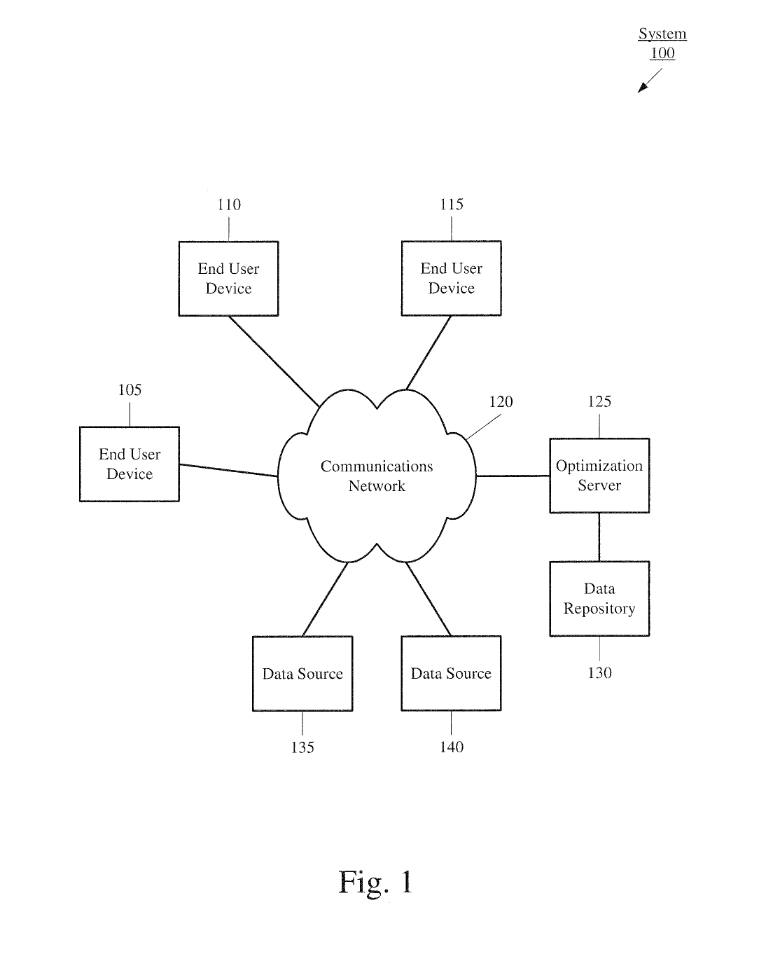

FIG. 1 shows an exemplary system 100 for resolving a gate conflict according to the exemplary embodiments. The system 100 relates to a communication between various components involved in resolving the gate conflict and updating an information repository used in the gate conflict resolution and for display on a user interface to a user. In providing these features according to the exemplary embodiments, the system 100 may include a plurality of end user devices 105-115, a communications network 120, an optimization server 125, a data repository 130, and a plurality of data sources 135-140.

The end user devices 105-115 may be any electronic device associated with respective users utilizing the features of the exemplary embodiments. Specifically, the end user devices 105-115 may be used by the respective users in updating the information repository and to view the user interface. Accordingly, the end user devices 110-115 may include the necessary hardware, software, and/or firmware to provide any display or the user interface for the features of the exemplary embodiments. For example, the end user devices 110-115 may be stationary devices (e.g., a desktop terminal) or mobile devices (e.g., a tablet, a laptop, etc.). The users may represent any entity that uses the exemplary embodiments such as an airline, an airport, an aircraft, a passenger, etc. That is, the users may be individuals or organizations who are airport and/or airline stakeholders.

The communications network 120 may be configured to communicatively connect the various components of the system 100 to exchange data. The communications network 120 may represent any single or plurality of networks used by the components of the system 100 to communicate with one another. For example, if the end user device 105 is used at an airport, the communications network 120 may include a private network with which the end user device 120 may initially connect (e.g. an airport network). The private network may connect to a network of an Internet Service Provider (ISP) to connect to the Internet. Subsequently, through the Internet, a connection may be established to other electronic devices. For example, the optimization server 125 may be remote relative to the airport but may be connected to the Internet. Thus, the end user device 105 may be communicatively connected to the optimization server 125. In another example, if the end user device 110 is used at a residence, the communications network 120 may include a network of an ISP to connect to the network. It should be noted that the communications network 120 and all networks that may be included therein may be any type of network. For example, the communications network 120 may be a local area network (LAN), a wide area network (WAN), a virtual LAN (VLAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc.

It is noted that the exemplary embodiments are described with regard to the end user devices 110-115 utilizing the features of the exemplary embodiments provided by the optimization server 125 using a connection via the communications network 120. For example, the exemplary embodiments may be implemented as a web service on a webpage hosted by the optimization server 125. In another example, the exemplary embodiments may be implemented as an application executed on the end user devices 105-115 but may rely on a data exchange with the optimization server 125. However, this manner of providing the features is only exemplary and other manners may also be implemented.

The optimization server 125 may be configured to receive inputs such as an identity of an arriving aircraft to determine an expected gate that the arriving aircraft is to use at the airport and resolving any gate conflicts with the expected gate. Specifically, the optimization server 125 may utilize available information such as estimates and actual data in performing this functionality. In resolving a gate conflict, the optimization server 125 may utilize a hybrid approach in which the optimization server 125 automatically determines whether there is a gate conflict such that a corresponding alert or notification may be provided to a user. Specifically, the optimization server 125 may utilize a set of rules that define when a set of conditions results in a gate conflict. The user may then manually determine the resolution through dynamically updated information provided through the user interface according to the exemplary embodiments while there is still time to resolve the gate conflict. The optimization server 125 may also utilize an automated approach by also automatically determining the resolution through compensation measures that may be used in maintaining the expected gate for the arriving aircraft or determining a new gate for the arriving aircraft. Specifically, the optimization server 125 may utilize a further set of rules that define a resolution based on the set of conditions. A corresponding alert or notification may be provided for this automated approach. The exemplary embodiments may be configured to utilize one or both approaches. For example, with the automated approach, the optimization server 125 may utilize the information and provide the corresponding outputs. With the hybrid approach, the optimization server 125 may perform the automated operations of determining a conflict and perform further automated operations in visualizing information for the user on the user interface such that a resolution input from the user may be received.

The data repository 130 may be any component that enables the optimization server 125 to store data used in resolving a gate conflict. As those skilled in the art will understand, the optimization server 125 may utilize a relatively large amount of data in dynamically updating the user interface and resolving gate conflicts. Accordingly, the optimization server 125 may store data in the data repository 130 as data is being requested from the data sources 135-140 which are being updated through automatic determinations and manual entries. The data repository 130 may also be used to store data that is not immediately being used by the optimization server 125 in resolving gate conflicts. For example, the optimization server 125 may manage data being stored in the data repository from the data sources 135-140 as a sliding window so that data that may be used in resolving a gate conflict for a subsequent arriving aircraft may be readily available.

The data sources 135-140 may represent any source of information that the optimization server 125 may use in resolving a gate conflict and providing the user interface. Initially, it is noted that the data sources 135-140 being represented as two separate sources is only exemplary. The system 100 may include any number of sources from which the optimization server 125 may receive information. For example, at least one of the data sources 135-140 may represent any source from which historical information may be received. In a first example of historical information, at least one of the data sources 135-140 may store time stamps associated with an aircraft corresponding to a respective position. In a second example of historical information, at least one of the data sources 135-140 may store map information (e.g., a layout of an airport, a layout of runways at the airport, etc.). In a third example of historical information, at least one of the data sources 135-140 may store historical weather information. Further types of historical information may include an aircraft type, a load factor, a gate, a runway, a filed route, a flown route, a density or congestion factor, a predictive sector loading, a region of interest, segment transit times, etc. In another example of information in the data sources 135-140, at least one of the data sources 135-140 may represent any source upon which live performance information may be received. It is noted that live performance information may relate to aircrafts or may also relate to current or predicted conditions. In a first example of the live performance information, at least one of the data sources 135-140 may store real-time information from passive and active radar systems as well as airport and airline information. In a second example of the live performance information, at least one of the data sources 135-140 may store weather forecasts. In a third example of the live performance information, at least one of the data sources 135-140 may store current runway conditions (e.g., construction areas, runway closings, etc.). Further types of live performance information may include a region of interest (e.g., a gate, a ramp, a taxiway, etc.) that may be defined by a geo-fence designed to capture activity in a specific geographical area, transit times, dwell times, an aircraft type, a filed route, flown route, a density or congestion factor, an actual sector loading, a region of interest, segment transit times (e.g., by aircraft, by previous flight activity including by similar type of aircraft, by the same route, by the same altitude, etc., etc.), etc.

In a particular implementation of the data sources 135-140, one of the data sources 135-140 may provide a data feed from a passive radar system and/or an active radar system. An exemplary passive radar system may be, for example, the PASSUR System sold by PASSUR Aerospace, Inc. of Stamford, Conn. An exemplary active radar system may be, for example, an FAA feed. The information provided by the active and/or passive radar systems may include target data points or positions for a particular aircraft. These target data points may include, for example, the time (e.g., UNIX time), the x-position, the y-position, altitude, x-velocity component, y-velocity component, z-velocity component, the speed, the flight number, the airline, the aircraft type, the tail number, etc.

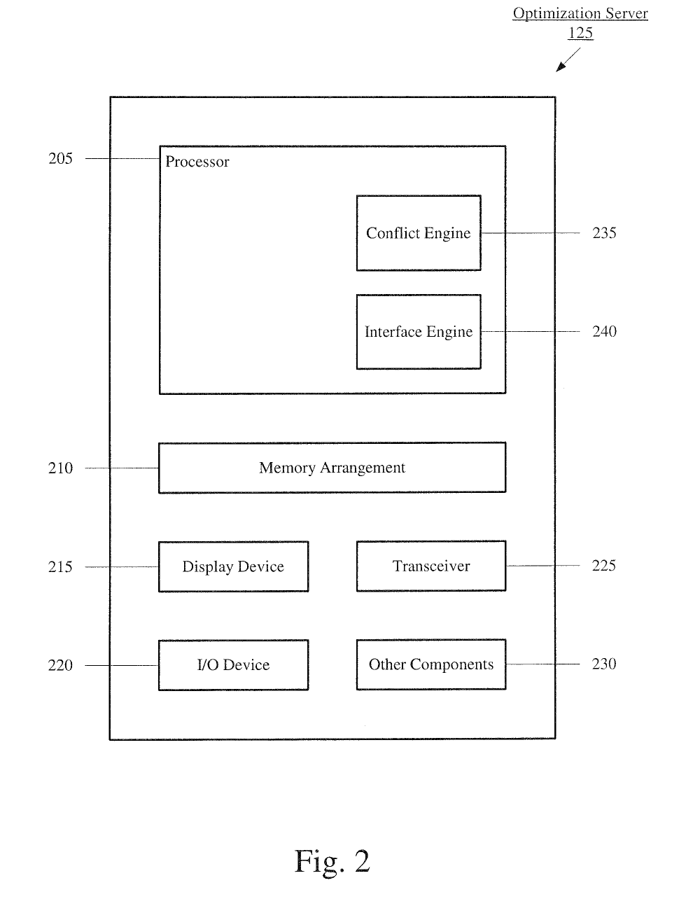

As noted above, the optimization server 125 may utilize the information from the data sources to determine and resolve a gate conflict as well as provide a user interface of pertinent or requested information. FIG. 2 shows the optimization server 125 of the system 100 according to the exemplary embodiments. Although the optimization server 125 is described as a network component (specifically a server), the optimization server 125 may be embodied in a variety of hardware components such as a portable device (e.g., a tablet, a smartphone, a laptop, etc.), a stationary device (e.g., a desktop terminal), incorporated into the end user devices 105-115, incorporated into a website service, incorporated as a cloud device, etc. The optimization server 125 may include a processor 205, a memory arrangement 210, a display device 215, an input and output (I/O) device 220, a transceiver 225, and other components 230 (e.g., an imager, an audio I/O device, a battery, a data acquisition device, ports to electrically connect the workflow server 150 to other electronic devices, etc.).

The processor 205 may be configured to execute a plurality of applications of the optimization server 125. The processor 205 may utilize a plurality of engines including a conflict engine 235 and an interface engine 240. As will be described in further detail below, the conflict engine 235 may be configured to receive an input of an identity of an arriving aircraft to determine an expected gate, determine where there is a conflict at the expected gate for the arriving aircraft, and resolving the conflict when there is one. The interface engine 240 may be configured to receive any information from a user, particularly when a manual approach is incorporated in the gate conflict resolution. The interface engine 240 may also provide the user interface along with the plurality of features according to the exemplary embodiments.

It should be noted that the above noted engines each being an application (e.g., a program) executed by the processor 205 is only exemplary. The functionality associated with the engines 235-240 may also be represented as components of one or more multifunctional programs, a separate incorporated component of the optimization server 125 or may be a modular component coupled to the optimization server 125, e.g., an integrated circuit with or without firmware.

The memory 210 may be a hardware component configured to store data related to operations performed by the optimization server 125. The display device 215 may be a hardware component configured to show data to a user while the I/O device 220 may be a hardware component that enables the user to enter inputs. For example, an administrator of the optimization server 125 may maintain and update the functionalities of the optimization server 125 through user interfaces shown on the display device 215 with inputs entered with the I/O device 220. It should be noted that the display device 215 and the I/O device 220 may be separate components or integrated together such as a touchscreen. The transceiver 225 may be a hardware component configured to transmit and/or receive data via the communications network 120.

According to the exemplary embodiments, the optimization server 125 may be configured to enable users to optimize critical operational, financial, and/or customer service objectives. In a particular optimization that encompasses operational, financial, and customer service objectives, the optimization server 125 resolves gate conflicts by ensuring that arriving aircraft may be gated-in on time without a gate hold. By alerting users in advance to a gate conflict using the hybrid approach or providing an automatically determined resolution using the automated approach (e.g., expediting push-back of aircraft using the gate prior to an arriving aircraft or reassignment of a new gate), the optimization server 125 may optimize the use of the gates of the airport. Therefore, delays may be minimized resulting from lack of gate availability.

The conflict engine 235 may receive an input of an identity of an arriving aircraft to assign a gate for the arriving aircraft. Specifically, the interface engine 240 may be configured to receive any information from a user including the identity of the arriving aircraft. For example, the interface engine 240 may provide a user interface for the user to enter the identity of the arriving aircraft. As noted above, the interface engine 240 may provide this user interface for inputs to be received and outputs to be displayed. In generating the user interface, a plurality of features according to the exemplary embodiments may be included.

The user interface provided by the interface engine 240 may track key operational metrics and decision areas and may incorporate any number of these metrics/areas as well as add any further metrics/areas. The user interface may utilize any manner of displaying the information to the user (e.g., a spreadsheet view including rows and columns). With regard to the metrics/areas, for a user interface directed to a departure schedule, the interface engine 240 may track metrics including aircraft call sign, aircraft type, aircraft tail number, assigned gate or hard stand, estimated off block time, actual off block time, expect departure clearance time, destination/departure fix, cancellation, tow information, etc. In another example, for a user interface directed to an arrival schedule, the interface engine 240 may track metrics including aircraft call sign, aircraft type, aircraft tail number, arrival runway, estimated time of arrival, actual time of arrival, assigned gate/stand (or expected gate), passenger load factor (including demographic information), cancellations, hold out entry/exit time (e.g., recorded for archives), and actual in block time. As the information being shown may become extensive, the interface engine 240 may incorporate a slew over feature in which first information is shown on the user interface and the user may view second information on the user interface by selecting to slew from the first information to the second information (e.g., a superimposed window).

In another type of user interface, gate allocations at an airport may be shown. Accordingly, each gate may be listed and assignments for each gate may be listed in a predetermined order (e.g., chronologically). The user interfaces provided by the interface engine 240 may include read and write privileges. For example, the read privileges may generally be given for public view or any authorized entity utilizing the feature of the exemplary embodiments. In another example, the write privileges may be given to airlines for only their respective aircraft/flights (e.g., to click airline priorities, click tow, enter actual off block times for tows and other departures where the actual off block times are not automatically determined, etc.)

Further information for the gates may also be included in the user interface and may also be viewed or edited based on corresponding privileges. For example, a ramp status may be included. In another example, a gate/jet bridge status may be shown. Specifically, a scheduled maintenance or outage (e.g., out of service) may be shown on the user interface. Additional information included in the user interface that may pertain at least indirectly to the gate may be a baggage belt status. For example, the user interface may show baggage belts that are out of service. In another example, the user interface may show baggage belts having baggage loaded and identify the corresponding aircraft/flights.

In a particular implementation, the interface engine 240 may provide a user interface including a departure sequencing allocation template (DSAT) screen. For this illustrative implementation, it may be assumed that an airport division and a selected airline have the ability to allocate gate assignments using the DSAT screen on the user interface and to rearrange gate assignments due to changes in airline arrival times also using the DSAT screen on the user interface. All other users may have restricted privileges (e.g., read only). Accordingly, this implementation may relate to the hybrid approach in which information is automatically generated but a resolution to a gate conflict is manually provided by a user.

In providing the user interface to the user of an entity viewing or editing gate information, the user interface may include information for schedules of aircraft/flights in a particular terminal and the corresponding gates at the terminal. The user interface may identify the terminal and gates. The gate allocations may be provided in a manner noted above where a spreadsheet format is used where expandable lengthwise columns including flight information is shown and gates are labeled horizontally as headers of these columns. Expected gates or gate allocations may be determined (e.g., automatically) based on arrival schedules and departure schedules or other estimated information or may be manually assigned by an authorized entity by viewing the arrival/departure schedules or other estimated information. A slew over feature may be included for other information to be shown (e.g., estimated time of arrival, actual time of arrival, actual in block time, tail number, destination or spot, tow actual off block time, etc.).

With regard to the gate conflict aspect, the DSAT screen of the user interface may populate the gate allocations for each gate with flight or aircraft identities. Upon allocation, the aircraft identity may be shown with a first color (e.g., blue) to indicate the allocation. That is, the first color may relate to an estimated time of arrival. The aircraft identity may be shown with a second color (e.g., red) to indicate that actual time of arrival information is received which indicates that the aircraft is on the ground. This second color may also indicate that the aircraft has landed but is not at a gate or slotted to be next at a gate (which is shown with a different color, noted below). Thus, a user may assign a gate and add the aircraft to a gate allocation list for the gate. For example, the second color may indicate an actual time of arrival. It is noted that the aircraft may be inserted at any point in the list (e.g., if the list is ordered chronologically) since the aircraft is already on the ground and the list may include arriving aircraft at a later time (e.g., still in transit).

In another scenario, when an aircraft enters a gate and an actual in block time is received, the aircraft identity may be shown with a third color (e.g., white) indicating that the aircraft is at the gate. Thus, the third color may indicate an actual in block time. The aircraft identity shown with the third color may remain in the gate allocation list indicating that the gate is occupied until the aircraft is towed or the aircraft turn is completed. Once the departing aircraft/tow actual off block time is received, the corresponding aircraft may be removed from the gate allocation list and an ensuing aircraft in the list for that gate may be shown using a fourth color (e.g., green) to indicate that the gate is available for the ensuing aircraft. That is, the fourth color may indicate a time cleared into the gate.

With a manual approach of updating the user interface, as information is being received (e.g., from pilots, crew, etc.) by the entity editing the user interface, the user may indicate or update the different stages of the aircraft. For example, when the aircraft at a particular gate is being towed, the pilot may provide an indication that the aircraft is a tow and the user may update the information for the aircraft by slewing over the aircraft identity and selecting the appropriate stage of “Tow”. This further status may be shown with a fifth color (e.g., orange) and may have a corresponding estimated off block time indicating a towed departure and an estimated time this will occur. Thus, the fifth color may indicate an estimated off block time.

While an aircraft is making a turnaround, the aircraft identity may remain the third color until a flight plan is detected with the same tail number and gate location at which time the aircraft identity replaces the arrival with the departure, thereby turning the aircraft identity the fifth color. If the aircraft has entered an estimated off block time, the time may appear next to the tow status. Once the actual off block time is received, the aircraft may be removed from the user interface and the next scheduled arrive for the gate may be automatically turned the fourth color (e.g., as indicated in the gate allocation list for the gate).

The user interface may also be used to identify whether an aircraft/flight is a priority. For example, the slew over feature may provide a menu in which the priority indication may be selected. The aircraft priority may also be determined automatically. For example, an aircraft/flight that is severely delayed for any number of reasons may require a relatively quick turnaround time to unload current passengers and load new passengers for an ensuing flight on the aircraft. The user interface may utilize any identifying characteristic (e.g., a further color, italics, bold, etc.) to indicate that the selected aircraft has an associated priority.

In a further feature that may be provided, the user interface may provide increased flexibility and speed in customizing the information that is shown to the user to reflect a specific operating environment, workflow requirements, and key operational/business metrics. In providing this further feature, the user interface may track and share critical information by flight (e.g., crew availability, queue sequence change request, critical connection information, etc.) so that a user may manage to a key objective (e.g., prioritizing a particular flight to gate-in or prioritizing a departure). The user interface may also create customized and flexible views of key information to provide an easier environment for a user to identify and focus on what is deemed important in a mission/role in the operation. With the above viewing manipulations, a focus on metrics of aircraft may be provided to the user.

This further feature may also enable editing privileges where freeform notes may be added by a user. The freeform notes may have viewing privileges that are selectable (e.g., local group only, global group only, public, etc.). Changes may be highlighted such that a user viewing the information in the user interface may be alerted of updates and changes. A unique indication may also be provided for updates to the freeform notes (e.g., notification visually on the user interface).

The interface engine 240 may additionally provide a legend that indicates the data sources 135-140 that are being used for the information being shown on the user interfaces. For example, the legend may indicate that information from a Traffic Flow Management (TFM) of the Federal Aviation Administration is included. The legend may use different colors to indicate the inclusion (e.g., green) or exclusion (e.g., red) of a data source. The legend may also be used by the user to select the data sources 135-140 that are to be used in creating the information of the user interfaces.

One particular type of information that may be included is traffic flow management weather information. This weather information may be from the National Weather Service, Aviation Weather Center that delivers consistent, timely, and accurate weather information. Those skilled in the art will understand that this data source is dedicated to working with users to enhance safe and efficient flights and is a trusted authority and leading innovator for aviation weather information. Due to a relative significance of this information and a conventional requirement to leave the platform on which the user interfaces are provided to reach this information, the interface engine 240 may include an icon on the user interface to link directly to a portal for this data source such that the corresponding weather information may be shown directly on the user interface (e.g., as a superimpose window). Accordingly, access to fifty five sources of naval air stations, airports, and aviation weather forecasts, products, and analytics may be provided via this icon to the portal.

The above illustrates a variety of different types of information that may be used in resolving gate conflicts. As noted above, the hybrid approach may be modified such that a further manual opportunity is included where the user also provides a manual input for an expected gate for a selected aircraft. In providing any manual input, the user may review any of the information that is being provided on the user interfaces (e.g., arrival/departure schedules, corresponding estimates, etc.). The automated approach by the conflict engine 235 may also utilize this information and metadata used in creating the display of the user interfaces to resolve a gate conflict. According to the exemplary embodiments, the interface engine 240 may also include actual departure demand in the information displayed on the user interfaces while the conflict engine 235 may use this actual departure demand information in resolving gate conflicts.

The actual departure demand may indicate an actual demand for each of the gates of an airport. Those skilled in the art will understand that conventional systems may use real/actual dynamically changing arrival demand for gates of an airport but only used departure demand as an estimate, based on the arrival/departure schedules. By determining the actual departure demand, the exemplary embodiments provide a significant expansion of an ability to proactively adjust to constantly changing airport departure demand (e.g., accelerating boarding and push-back of a high value flight to take advantage of a lull in demand and small departure queue). The exemplary embodiments also provide a tactical and near-term predictive gate planning feature that reflects true demand, including revised proposed times, delays, and cancellations.

The actual departure demand may be determined, for example, on a rolling hourly basis, looking ahead for up to a predetermined amount of time (e.g., 16 hours). The interface engine 240 may determine actual departure demands based on airline schedule data, active-state “out” status, and removal of cancelled flights from demand and arrival calculations.

In resolving the gate using the hybrid approach, the conflict engine 235 may provide the pertinent information including the actual departure demand information to the user on user interfaces including all this information. Based on an expected gate for the aircraft that is determined automatically or based on a manual input that is received, the conflict engine 235 may indicate whether a gate conflict may arise. For example, a particular arriving aircraft that is selected for review may be assigned a gate that is currently occupied by another aircraft. In determining this gate conflict, the conflict engine 235 may generate a notification for the user indicating this gate conflict. The notification may be provided such that the user has sufficient time to attempt to resolve the issue. For example, the user may select to assign a new gate to the selected aircraft. In another example, the user may select to utilize compensation measures such as expediting a departure of the gate occupying aircraft. When the user has selected the appropriate resolution, the user may enter the updated information in the user interface. The user interface may update all corresponding information that is affected by the manually input resolution.

It is noted that the conflict engine 235 may be configured to analyze the manually input resolution. By analyzing the resolution provided by the user, the conflict engine 235 may determine the effects of this resolution. If the conflict engine 235 determines that an effect has an unacceptable parameter (e.g., an increased delay of a further aircraft beyond an acceptable threshold), the conflict engine 235 may provide a further notification such that the user may also attempt to resolve this issue or modify the resolution to the previous gate conflict.

In resolving the gate using the automated approach, the conflict engine 235 may utilize the above described information that is included in the user interfaces. Based on this information, the gate conflict may be identified and a resolution may then be determined. In a substantially similar manner as the hybrid approach, the conflict engine 235 may determine compensation measures that may be used to resolve the gate conflict and maintain use of the expected gate for the selected aircraft. If compensation measures are not capable of providing an acceptable resolution (e.g., a decrease in delay does not meet an unacceptable threshold), the conflict engine 235 may determine a new gate to be assigned the selected aircraft. In determining the new gate, the conflict engine 235 may consider all consequences of assigning the new gate. Upon automatically determining a resolution for the gate conflict, the conflict engine 235 may provide a notification to the user indicating the update for the selected aircraft (e.g., when a new gate is assigned) or the procedure to be used (e.g., for prior aircraft using the expected gate).

The conflict engine 235 may generate the notifications based on a variety of factors. For example, the conflict engine 235 may provide the notifications for the user to maintain control of operational concerns that are of importance (e.g., gate conflicts, tarmac delays, extended taxi queues, long deicing queues, etc.).

The conflict engine 235 may also be configured to provide notifications to a user based on user preferences. For example, although an option may be used to provide notifications whenever an event has occurred (e.g., a gate conflict is determined) or a change/update has been made, the exemplary embodiments may utilize a set of rules that define when a particular user is to be notified for a given metric or change. The conflict engine 235 may alert users with up-to-date information and statuses of critical operational elements as selected by the respective user. For example, an appropriate user may be notified of tarmac delays to an imminent arrival of an aircraft to a particular gate.

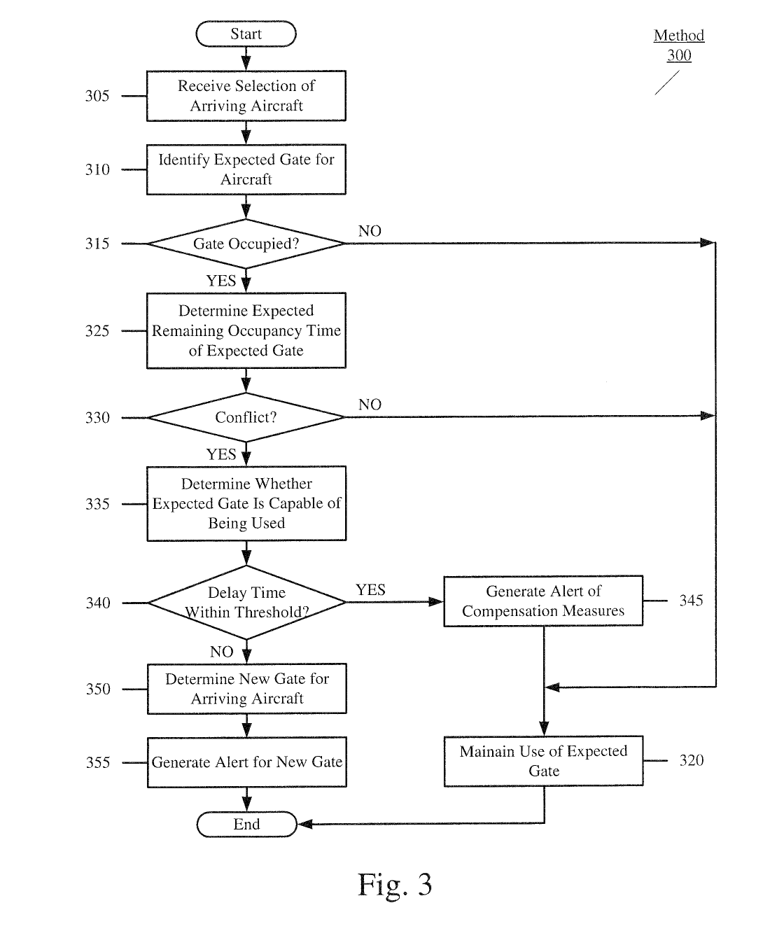

FIG. 3 shows a method 300 of resolving a gate conflict according to the exemplary embodiments. Specifically, the method 300 may relate to resolving the gate conflict that may arise for an arriving aircraft that has had an expected gate determined based on estimates and other information that was available at the time a expected gate was determined. The method 300 will be described from the perspective of the optimization server 125 utilizing an automated approach in which the output is a resolution to the gate conflict. The method 300 will also be described with regard to the system 100 of FIG. 1 and the optimization server 125 of FIG. 2. It is noted that the method 300 will utilize specific considerations and factors. However, as will be noted below wherever appropriate, the method 300 may also utilize further and/or additional considerations/factors such as the plurality of factors described above.

In 305, the optimization server 125 receives a selection of an arriving aircraft. As noted above, the use of the arriving aircraft is only exemplary and any aircraft that will require use of a gate at the airport may be selected. The selection of the arriving aircraft may include a unique identification. For example, the identification may be an aircraft number, a flight number (with date/time), a tail number, etc.

In 310, the optimization server 125 identifies an expected gate for the aircraft. As noted above, the optimization server 125 may be configured to automatically determine the expected gate based on available information such as arrival/departure schedules. Using this information, a gate may be selected and assigned for use by the aircraft at an expected arrival time. The expected gate may also be manually selected by a user and a corresponding input may be provided for this information.

In 315, the optimization server 125 determines whether the identified expected gate is occupied. In one manner, occupancy may relate to whether an aircraft is currently physically using the expected gate. In another manner, occupancy may not necessarily pertain to whether there is a physical presence but whether there is a potential that an aircraft will occupy the expected gate at the time the selected aircraft is expected to use the expected gate. If the expected gate is not occupied, the optimization server 125 proceeds to 320 where use of the expected gate is maintained for the selected arriving aircraft.

If the expected gate is occupied, in 325, the optimization server 125 determines an expected remaining occupancy time of the expected gate. In determining the expected remaining occupancy time, the optimization server 125 may determine how use of the expected gate for the selected arriving aircraft will affect timing parameters (e.g., turnaround time). In 330, the optimization server 125 determines whether there is a gate conflict at the expected gate for the selected arriving aircraft based on the expected remaining occupancy time. As noted above, the gate conflict being based on the expected remaining occupancy time is only exemplary and the gate conflict may be based on any number of reasons that may arise from the selected arriving aircraft being assigned the expected gate. Although occupied, if there is no gate conflict, the optimization server 125 proceeds to 320 where use of the expected gate is maintained.

If there is a gate conflict, in 335, the optimization server 125 determines whether the expected gate is capable of still being used for the selected arriving aircraft. That is, despite being occupied and a gate conflict being determined, there may still be circumstances that enable the use of the expected gate to be maintained. In this manner, the optimization server 125 may determine various permutations that may be used in determining whether the expected gate is a viable option for the selected arriving aircraft. Specifically, the optimization server 125 may run through scenarios that utilize compensation measures. The compensation measures may be, for example, expediting departures of aircraft using the expected gate prior to the selected arriving aircraft.

In 340, the optimization server 125 determines whether a delay time from using the compensation measures are within an acceptable threshold for the selected arriving aircraft. It is again noted that the delay time being the metric that is to be satisfied for maintaining use of the expected gate is only exemplary. The exemplary embodiments may utilize any operational metric or combination of metrics that is to be satisfied for the expected gate to be used for the selected arriving aircraft. If the delay time is within the acceptable threshold, in 345, the optimization server 125 generates an alert indicating the compensation measures that are to be used for the use of the expected gate to be maintained. Those skilled in the art will understand that maintaining use of an assigned gate may entail a minimum number of residual effects to the other gates. Therefore, in one exemplary implementation, the optimization server 125 may strive to maintain use of an expected gate prior to resorting to assigning a new gate. However, if the delay time is not within the acceptable threshold even if compensation measures are used, in 350, the optimization server 125 determines a new gate to be assigned to the selected arriving aircraft. As noted above, the new gate may be determined in a holistic manner such that the overall effect from using a new gate minimizes subsequent delays that may arise, particularly at the new gate. Accordingly, in 355, the optimization server 355 generates an alert for the new gate being assigned to the selected arriving aircraft.

It is noted that the method 300 may include additional operations. For example, the alerts may be generated for select users based on user preference. Thus, a determination may be made whether the alert corresponds to a level or defined parameter that warrants the alert being provided to the user. If the alert is warranted, the method 300 may continue to 345 or 355. However, if the alert is not warranted, the method 300 may apply the changes (e.g., providing the new gate information to the pilot and crew, providing instructions to the crew for expedited departure procedures, etc.).

The exemplary embodiments describe a device, system, and method for optimizing use of gates at an airport by resolving gate conflicts. When using an automated approach, the exemplary embodiments may utilize information including actual departure demand that factors into how a gate conflict (including gate assignments) is resolved. When using a hybrid approach in which at least one manual input is used in resolving a gate conflict, the exemplary embodiments may provide a plurality of user interfaces that provide a wide variety of different types of information that may be used by a user to determine how a gate assignment/conflict is to be resolved.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present disclosure, without departing from the spirit or the scope of the disclosure. Thus, it is intended that the present disclosure cover modifications and variations of this invention provided they come within the scope of the appended claims and their equivalent.

What is claimed is:

1. A method, comprising:
at an optimization server:
receiving an identification identifying an aircraft;
identifying a gate assigned to the aircraft upon landing at a destination including the gate;
determining whether a gate conflict is expected for the aircraft to use the gate;
when there is a gate conflict, determining a resolution for the gate conflict based on actual departure demand information of the gate; and
providing a notification corresponding to the resolution.

2. The method of claim 1, wherein the gate conflict is one of a physical occupancy or an expected occupancy of the gate by a further aircraft.

3. The method of claim 1, wherein the resolution is a selection of a new gate.

4. The method of claim 3, further comprising:
automatically updating a user interface defining gate assignments with the new gate for the aircraft.

5. The method of claim 1, wherein the resolution is expedited operations for a prior aircraft using the gate.

6. The method of claim 5, further comprising:
automatically providing an alert to corresponding crew members of the expedited operations.

7. The method of claim 5, wherein the expedited operations include an expedited departure of the prior aircraft.

8. The method of claim 1, wherein the actual departure demand information is based on airline schedule data, activate-state out status data, cancelled flight data, or a combination thereof.

9. The method of claim 1, further comprising:
receiving a manual input corresponding to the gate being assigned to the aircraft.

10. The method of claim 1, further comprising:
determining the gate being assigned to the aircraft based on time estimate information.

11. The method of claim 1, further comprising:
identifying user preferences associated with a user being provided the notification;
determining whether the notification is to be provided based on the user preference.

12. The method of claim 1, further comprising:
receiving a manual input corresponding to a further resolution,
wherein the further resolution overrides the resolution.

13. The method of claim 12, further comprising:
providing a user interface indicating when the gate conflict is determined.

14. An optimization server, comprising:
a transceiver configured to receive an identification identifying an aircraft; and
a processor identifying a gate assigned to the aircraft upon landing at a destination including the gate, the processor determining whether a gate conflict is expected for the aircraft to use the gate, when there is a gate conflict, the processor determining a resolution for the gate conflict based on actual departure demand information of the gate, the processor generating a notification corresponding to the resolution.

15. The optimization server of claim 14, wherein the gate conflict is one of a physical occupancy or an expected occupancy of the gate by a further aircraft.

16. The optimization server of claim 14, wherein the resolution is a selection of a new gate.

17. The optimization server of claim 14, wherein the resolution is expedited operations for a prior aircraft using the gate.

18. The optimization server of claim 14, wherein the actual departure demand information is based on airline schedule data, activate-state out status data, cancelled flight data, or a combination thereof.

19. The optimization server of claim 14, wherein the processor generates a user interface indicating when the gate conflict is determined, and wherein the transceiver receives a manual input corresponding to a further resolution, the further resolution overriding the resolution.

20. An optimization server, comprising:
first circuitry for receiving an identification identifying an aircraft;
second circuitry for identifying a gate assigned to the aircraft upon landing at a destination including the gate;
third circuitry for determining whether a gate conflict is expected for the aircraft to use the gate;
when there is a gate conflict, fourth circuitry for determining a resolution for the gate conflict based on actual departure demand information of the gate; and
fifth circuitry for providing a notification corresponding to the resolution
